(19) United States
(12) Patent Application Publication
(10) Pub. No.: US 2005/0221796 A1
(43) Pub. Date: Oct. 6, 2005

(54) Personal portable security system

(76) Inventors: Gerald Pellegrino, Framingham, MA (US); William Vincent Zeliff, Stow, MA (US)

Correspondence Address: STEUBING AND MCGUINESS & MANARAS LLP, 125 NAGOG PARK, ACTON, MA, 01720, US

(21) Appl. No.: 10/814,209

(22) Filed: Mar. 31, 2004

(51) Int. Cl. H04M 1/68

(52) U.S. Cl. 455/410; 455/456.6

(57) ABSTRACT

A security system takes advantage of personal wireless technology to provide enhanced security for individuals. A wireless communications device, e.g. a cell phone or a personal digital assistant, is used to contact a security provider. The security provider is capable of responding to the contact to ascertain the identity of the user and the location of the user of the wireless communications device. The security provider can then contact an emergency response center to provide aid to the user of the wireless communications device. Keystrokes or photographic information can be sent from the wireless communications device to convey information such as location or nature of the emergency, and the security provider can contact an appropriate specific type of emergency response center in response to the information received.

### FIELD OF THE INVENTION

The present invention relates generally to personal security systems and more particularly to the use of wireless devices and wireless service providers to provide personal security for a wireless device user.

### BACKGROUND OF THE INVENTION

When an individual encounters an emergency situation, their only currently available option is to use a telephone to call 911. Valuable time is wasted dialing, and further time is lost explaining to the operator the identity of the individual, the individual's location, and the nature of the problem.

Meanwhile, wireless devices, such as cellular phones or personal data accessories (PDAs), have quickly become ubiquitous. Such devices are currently used as communications tools, for example to call other people or to download e-mail regardless of location.

It would be highly advantageous to employ the advantages of wireless technology to provide new and enhanced security services.

### SUMMARY OF THE INVENTION

A novel security system takes advantage of personal wireless technology to provide enhanced security for individuals. The system includes a wireless communications device, which may be for example a cell phone or a personal digital assistant. A security provider is capable of responding to contact from a user of the wireless communications device to ascertain the identity of the user and the location of the user of the wireless communications device. The security provider can then contact an emergency response center to provide aid to the user of the wireless communications device.

In accordance with a further aspect of the invention, the security provider is capable of automatically ascertaining the location of the user of the wireless communications device in response to said contact, for example via GPS.

More particularly, contact from a user may include keystrokes associated with the user's location. The security provider is capable of ascertaining the location of the user of the wireless communications device via interpretation of the keystrokes.

In accordance with another aspect of the invention, the security provider is further capable of ascertaining the nature of the user's emergency, and can then contact a specific emergency response center selected in response to the nature of the user's emergency.

According to a further aspect of the invention, the wireless communications device is capable of photography, and contact from the user includes photographic data. The security provider is capable of ascertaining information about the user's emergency situation in response to the photographic data.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a representation of a security system employing a wireless device and security provider in accordance with the principles of the invention.

FIG. 2 is a flow diagram representing user and security provider actions in accordance with one embodiment of the principles of the invention.

FIG. 3 is a flow diagram representing user and security provider actions in accordance with another embodiment of the invention.

FIG. 4 is a flow diagram representing user and security provider actions in accordance with another embodiment of the invention.

FIG. 5 is a flow diagram representing user and security provider actions in accordance with another aspect of the principles of the invention.

FIG. 6 is a flow diagram representing user and security provider actions in accordance with a further aspect of the principles of the invention.

### DETAILED DESCRIPTION OF EXEMPLARY EMBODIMENTS

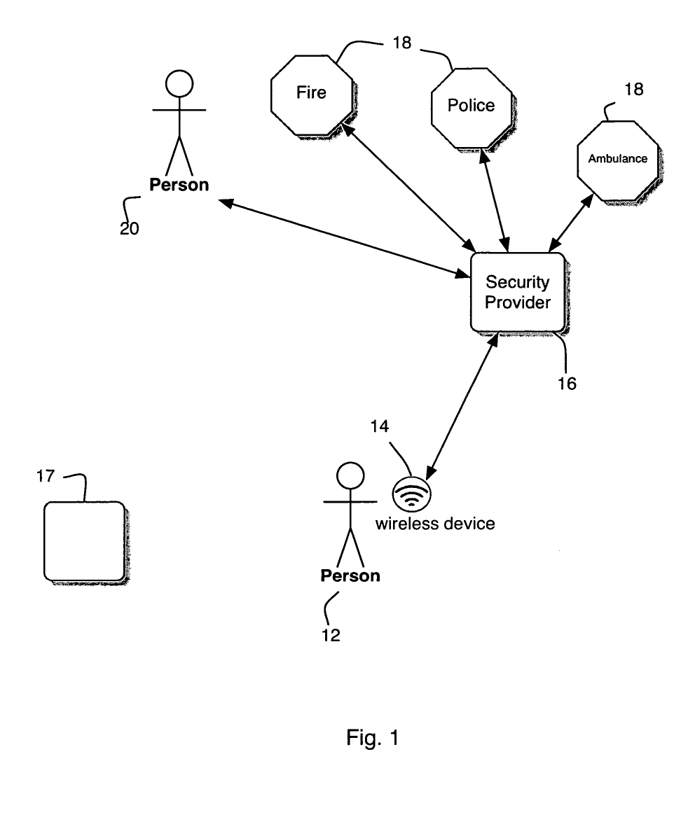

Referring to FIG. 1, there is shown an example of a wireless security system 10 employing the present invention. A wireless user 12 carries a wireless device 14. The wireless device 14 may be any of several known types. The wireless device 14 may be a cellular phone employing, for example but not limited to, CMTS, UMTS, or GSM cellular technology. Alternatively, the wireless device may be a wireless networking phone employing for example 802.11 technology, or may be a wireless PDA device employing a proprietary packet radio protocol (e.g. a blackberry handheld device). The invention is not limited to the capabilities of current wireless devices and can be continually employed as wireless technologies evolve.

The wireless device 14 is in wireless contact with a security provider 16. The security provider 16 may be employed within an existing service provider, such as a cellular phone service provider, or a wireless networking provider, or a satellite phone or networking provider. Alternately, the security provider 16 may be an independent provider for the primary purpose of providing individual security services. In accordance with an aspect of the invention, the services provided by the security provider 16 can vary depending upon the level of service and protection desired or required by the user 12, and/or the level of service the user 12 is willing to pay for.

The security provider 16 is in turn in communication with an emergency response center 18. An emergency response center 18 may be any of, and not limited to, a police station, a fire station, a hospital or paramedics, a private security company, or an individual 20 previously specified by the user 12.

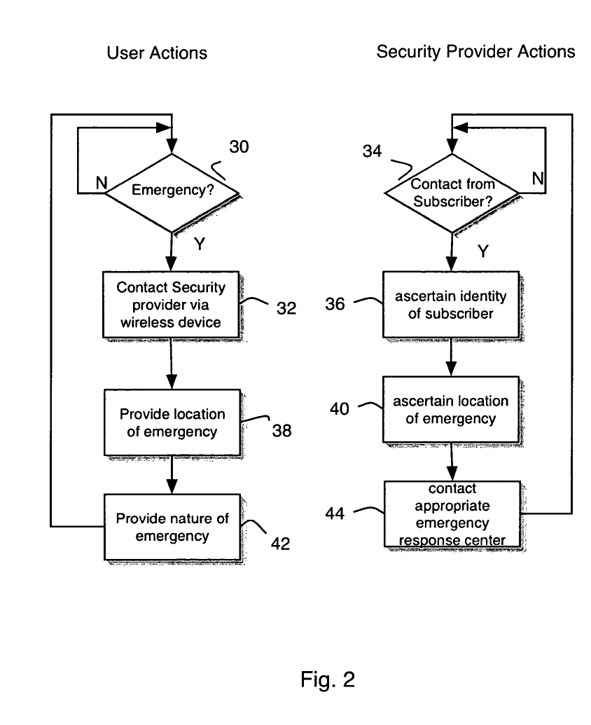

In accordance with one implementation of the invention, the user 12 has a subscription to a service level contract with the security provider 16. Different service level contracts can be purchased based upon services required and the amount of money the user is willing to pay. Referring to FIG. 2, there are shown the actions taken by the user 12 and the security provider 16 in accordance with the invention. Assume the user 12 finds herself in a position of vulnerability wherein security is required (step 30). For example, the user 12 may have left her workplace 17 and noticed that she is being followed by an individual. If the user 12 has subscribed to a service level contract providing a high level of security services, the user 12 can access her wireless device 14 and press a key or enter a code that automatically connects her with a person at the security provider 16 (step 32). Once contacted by the subscriber user 12 (step 34), the security provider 16 can ascertain the identity of the subscriber (step 36). If the user 12 is using a cellular phone, the user 12's identity can be ascertained by the calling phone number. If a the user 12 is using a wireless networking device, the identity of the user may be ascertained for example from the network address of the device or an application level identifier such as an e-mail address.

The user 12 can then provide her location to the security provider 16 (step 38, step 40). If the wireless device 14 is a cellular or wireless networking phone, the simple act of speaking with a person on the phone can deter an otherwise likely attack.

Furthermore, the security provider 16 can have previously provided the user 12 with certain code words or keystrokes to be transmitted during any dangerous or emergency situation. The code word or keystroke is used by the user 12 to alert the security provider 16 to the type of situation being faced (step 42). For example, one code word or keystroke might indicate that the user 12 is being followed. Another code word or keystroke might indicate that the user is trapped or cornered in an area. Another code word or keystroke might indicate that the user has observed criminal activity, or observed a situation requiring an emergency response. The security provider 16 can use the key words or keystrokes to determine which of several different types of emergency response centers 18 should be contacted to help the user 12 (step 44).

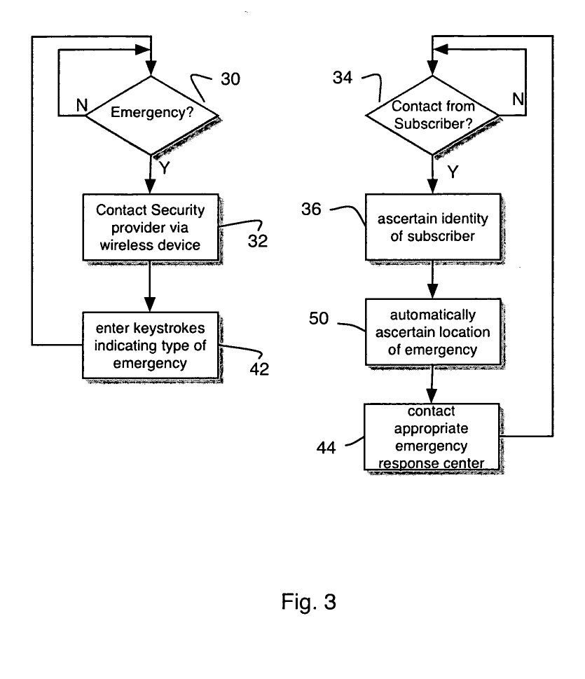

As previously described, the user 12 may indicate her location verbally if using a wireless or cellular phone, and this information can be transferred from the security provider 16 to the proper emergency response center 18. Alternately, the user 12's location can be obtained automatically through several different means. Referring to FIG. 3, the user 12 and security provider 16 actions are the same as those shown in FIG. 2 except that the user need not manually provide her location (FIG. 2 step 38). Instead, the security provider 16 automatically ascertains the user 12's location (FIG. 3 step 50). First of all, the user 12's wireless device 14 may be global positioning satellite (GPS) enabled. If so, the security provider 16 can use the GPS capability of the wireless device to locate the user 12. For example, when subscribing for a contract, the user 12 can provide a serial number or other identifying information (e.g. a phone number) to identify the user 12's wireless device. This information can then be used in turn by the security provider 16 to locate the device via GPS. Alternatively, cellular phone providers will be required to provide 911 location services in accordance with the FCC's required wireless Enhanced 911 (E911) rules. The technical means for providing these services could be employed to locate the user 12. Once the security provider 16 has ascertained the identity of the user 12 and the location of the user 12, this information is passed on to the appropriate emergency response center 18. A physical description of the user 12 can also be provided to the emergency response center 18 by the security provider 16 to further aid in the efficient provision of emergency services.

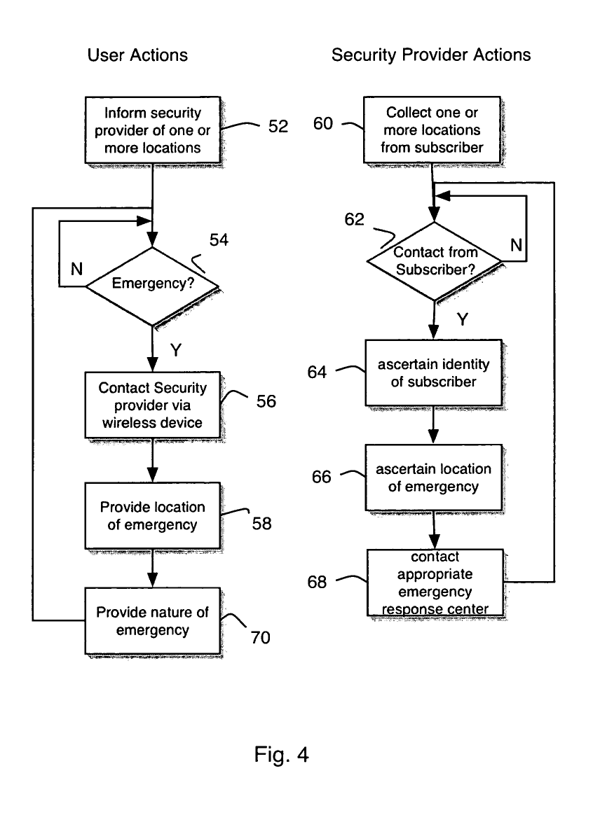

In accordance with an alternate embodiment of the invention as shown in FIG. 4, dynamic location determination is not required. Instead, the user 12 informs the security provider 16 of any number of key locations where the user 12 expects to be located on a regular basis (step 52). For example, the user 12 might select their home, their place of work, their school, etc. Each selected location is associated with a physical address and a corresponding keypad number. Should an emergency situation arise at any of the pre-programmed locations (step 54), the user 12 can contact the security service 16 via the user's wireless device 14 (step 56). The security service may be contacted for example through a pre-programmed phone number if the wireless device is a cellular phone, or through an instant message if the wireless device is a handheld networking device. Once the security service 16 has been contacted, the user 12 enters the pre-programmed keypad number associated with the user's present location (step 58).

Meanwhile, once the security service 16 collects the user 12's location information (step 60), then if the security service 16 is contacted by the user 12 (step 62), the security service 16 can identify the user 12 by means previously described (step 64) and can ascertain the location of the user 12 via the keystrokes transmitted by the user 12 (step 66). The security provider 16 can then contact an emergency response center 18 (step 68). In accordance with a further aspect of the invention, pre-programmed keystrokes could be associated with the type of emergency the user 12 is experiencing (step 70), enabling the security service 16 to contact a specific type of emergency response center 18.

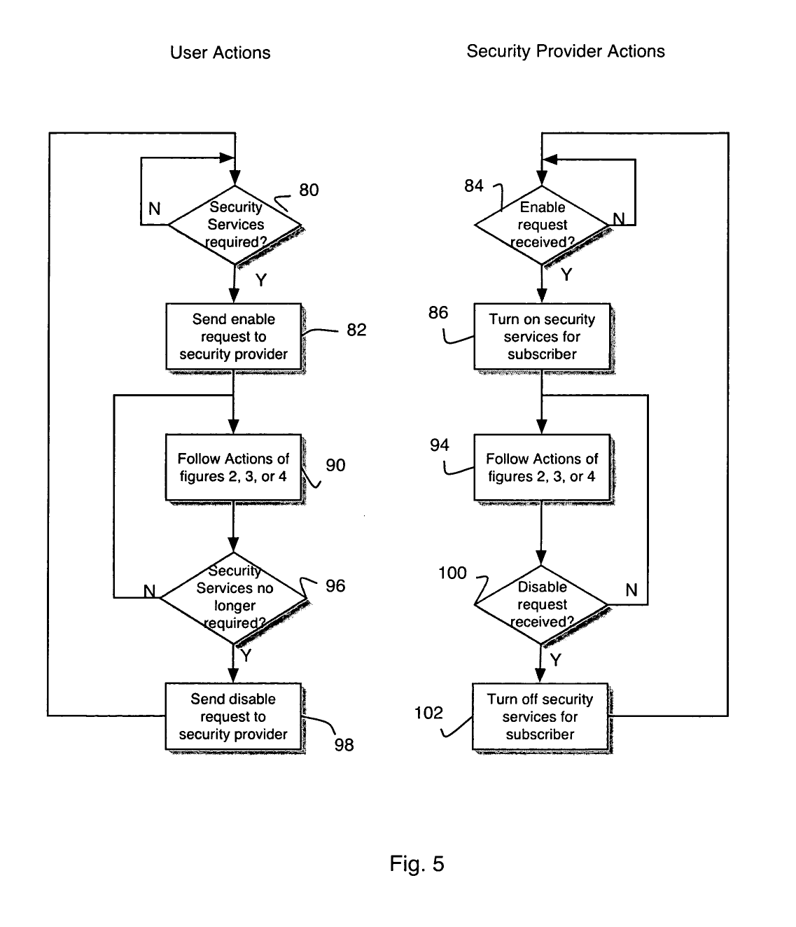

The user 12 can contact the security service 16 only as needed, as previously described. Or, as shown in FIG. 5, the user 12 can enable the security provider 16 to provide protection at certain times. For example, when the user 12 leaves her place of work and desires security services (step 80), she can contact the security provider 16 through any manner previously described and enter an “enable” code via, for example, a pre-programmed keystroke (step 82). Upon receipt of the enable request from the user 12 (step 84), The security provider 16 turns on the security services subscribed by the user 12 (step 86). While the security services are enabled, then in the event of an emergency, the user 12 can provide the necessary information to the security provider 16 in any of the manners previously described in FIGS. 2, 3, and 4 (step 90). Likewise, if the security provider 16 is contacted by the subscriber user 12, the security provider 16 ascertain the identity and the location of the user 12 and call an appropriate emergency response center 18 in any of the manners previously described in FIGS. 2, 3, and 4 (step 94). Once the user 12 no longer requires security services (step 96), then the user can disable the security service 16, for example, when she is safely in her car. A disable request can be sent via a pre-programmed keystroke or series thereof, or, if the wireless device is a cellular phone, simply by terminating the call to the security service 16 (step 98). Once the disable request is received by the security provider 16 (step 100), the security services for the subscriber user 12 are turned off (step 102).

In accordance with another aspect of the invention, the user 12 can contact another second party 20 in the event of an emergency via the security service 16. The second party 20 may be for example the parent of a child user 12, a college roommate, a teacher, or a close friend or family member. In this case, in the event of an emergency, the security service 16 would contact either or both of an emergency response center 18 and the second party 20.

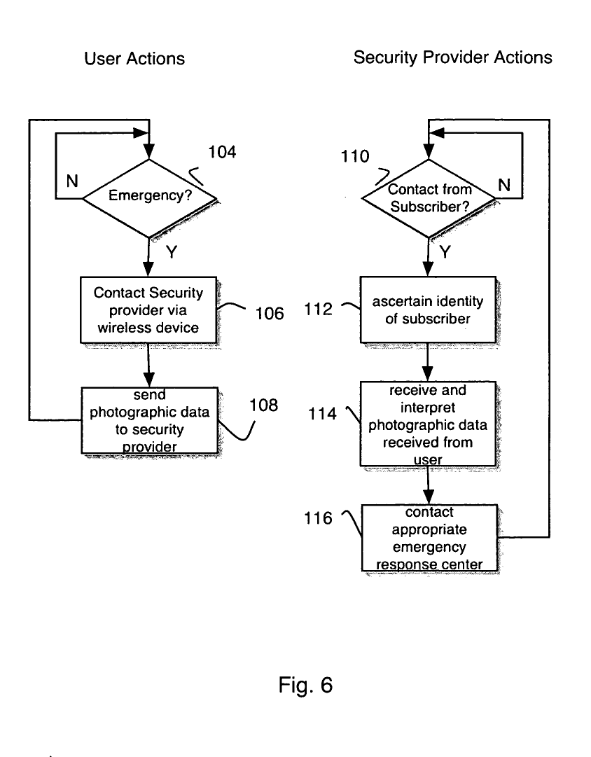

A further aspect of the invention takes advantage of photographic capabilities of certain wireless devices. Some recently available cellular phones include cameras. The cameras can be used to take digital photographs and send the data wirelessly over the cellular network to a chosen destination. A user 12 in possession of such a wireless device 14 having photographic capabilities can use it to advantage in event of an emergency. Referring to FIG. 6, in the event of an emergency (step 104), after contacting the security service 16 in any manner previously described (step 106), the user 12 can photograph her surroundings, or for example an assailant, and send the photographs to the security service 16, for example via pre-programmed keystrokes (step 108). Once the security provider 16 is contacted by the user 12 (step 110), the security provider 16 ascertains the identity and location of the subscriber in any aforementioned manner (step 112), and receives and interprets the photographic data received from the user (step 114). The photographic data can further aid the security provider in determining the nature and location of the emergency, and can aid the security provider in containing the appropriate emergency response center (step 116). The photographic information may further aid emergency response centers 18.

The previously described invention can be useful as a supplement to an existing alarm system. For example, a hard-wired alarm system in a house or office can be used to notify police of a problem, but does not identify the individual or the type of problem being encountered. The addition of the described invention can add further important information, and would be useful for example by a disabled elderly client or a child or babysitter. In addition, the inventive system is not subject to power or phone line outages at the location where it is used, further adding to its advantages.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the invention. Further, although aspects of the present invention have been described herein in the context of several particular implementations in particular environments for particular purposes, those of ordinary skill in the art will recognize that its usefulness is not limited thereto and that the present invention can be beneficially implemented in any number of environments for any number of purposes. For example, though the invention has been described in terms of a security system, all its functionality would be useful in any situation where immediate contact with a third party is required.

1. A security system comprising:
a portable wireless communications device;
a security provider for responding to contact from a user of the wireless communications device, the security provider capable of ascertaining the identity of the user and the location of the user of the wireless communications device in response to said contact;
the security provider operable to contact an emergency response center to provide aid to the user of the wireless communications device.

2. The security system of claim 1 wherein the security provider is capable of automatically ascertaining the location of the user of the wireless communications device in response to said contact.

3. The security system of claim 2 wherein the wireless communications device is GPS technology capable and wherein the security provider is capable of automatically ascertaining the location of the user of the wireless communications device in response to said contact via GPS technology.

4. The security system of claim 1 wherein said contact from a user includes keystrokes associated with the user's location, and wherein the security provider is capable of ascertaining the location of the user of the wireless communications device in response to said contact via interpretation of said keystrokes.

5. The security system of claim 1 wherein the security provider is further capable of ascertaining the nature of the user's emergency in response to said contact;
and wherein the security provider is operable to contact a specific emergency response center to provide aid to the user of the wireless communications device, the specific emergency response center selected in response to the nature of the user's emergency.

6. The security system of claim 5 wherein said contact from a user includes keystrokes associated with the nature of the user's emergency, and wherein the security provider is capable of ascertaining the nature of the user's emergency in response to said contact via interpretation of said keystrokes.

7. The security system of claim 1 wherein the wireless communications device is capable of photography, and wherein contact from a user includes photographic data from the wireless communications device, and wherein the security provider is further capable of ascertaining information about the user's emergency situation in response to the contact.

8. The security system of claim 1 wherein the wireless communications device is a cellular phone.

9. The security system of claim 1 wherein the wireless communications device is a personal digital assistant.

10. A security provider for responding to contact from a user of a wireless communications device,
the security provider capable of ascertaining the identity of the user and the location of the user of the wireless communications device in response to said contact;
the security provider operable to contact an emergency response center to provide aid to the user of the wireless communications device.

11. The security provider of claim 10 wherein the security provider is capable of automatically ascertaining the location of the user of the wireless communications device in response to said contact.

12. The security provider of claim 11 wherein the wireless communications device is GPS technology capable and wherein the security provider is capable of automatically ascertaining the location of the user of the wireless communications device in response to said contact via GPS technology.

13. The security provider of claim 10 wherein said contact from a user includes keystrokes associated with the user's location,,and wherein the security provider is capable of ascertaining the location of the user of the wireless communications device in response to said contact via interpretation of said keystrokes.

14. The security provider of claim 10 wherein the security provider is further capable of ascertaining the nature of the user's emergency in response to said contact;
and wherein the security provider is operable to contact a specific emergency response center to provide aid to the user of the wireless device, the specific emergency response center selected in response to the nature of the user's emergency.

15. The security provider of claim 14 wherein said contact from a user includes keystrokes associated with the nature of the user's emergency, and wherein the security provider is capable of ascertaining the nature of the user's emergency in response to said contact via interpretation of said keystrokes.

16. The security provider of claim 10 wherein the wireless communications device is capable of photography, and wherein contact from a user includes photographic data from the wireless communications device, and wherein the security provider is further capable of ascertaining information about the user's emergency situation in response to the contact.

17. The security provider of claim 10 wherein the wireless communications device is a cellular phone.

18. The security provider of claim 10 wherein the wireless communications device is a personal digital assistant.

19. A method of providing security comprising the steps of:
responding to contact from a user of a wireless communications device;
ascertaining the identity of the user and the location of the user of the wireless communications device in response to said contact;
contacting an emergency response center to provide aid to the user of the wireless communications device.

20. The method of claim 19 wherein the step of ascertaining the location of the user of the wireless communications device in response to said contact is performed automatically.

21. The method of claim 20 wherein the wireless communications device is GPS technology capable and wherein the step of ascertaining the location of the user of the wireless communications device in response to said contact is performed via use of GPS technology.

22. The method of claim 19 wherein said contact from a user includes keystrokes associated with the user's location, and wherein the step of ascertaining the location of the user of the wireless communications device in response to said contact is performed via interpretation of said keystrokes.

23. The method of claim 19 further comprising the step of ascertaining the nature of the user's emergency in response to said contact;
and the step of contacting an emergency response center includes contacting a specific emergency response center selected in response to the nature of the user's emergency.

24. The method of claim 23 wherein said contact from a user includes keystrokes associated with the nature of the user's emergency, and wherein the step of ascertaining the nature of the user's emergency in response to said contact is performed via interpretation of said keystrokes.

25. The method of claim 19 wherein the wireless communications device is capable of photography, and wherein contact from a user includes photographic data from the wireless communications device, and wherein the method further comprises the step of ascertaining information about the user's emergency situation in response to the contact.
